(19) United States
(12) Patent Application Publication
(10) Pub. No.: US 2017/0297033 A1
(43) Pub. Date: Oct. 19, 2017

(54) ELECTRIC TOBACCO GRINDER

(71) Applicant: Lrider Technology Co.,Ltd, Shenzhen (CN)

(72) Inventor: Yongsheng LI, Shenzhen (CN)

(73) Assignee: Lrider Technology Co.,Ltd, Shenzhen (CN)

(21) Appl. No.: 15/099,604

(22) Filed: Apr. 15, 2016

(51) Int. Cl. B02C 18/24; A24B 7/04; B02C 18/08; B02C 18/16

(52) U.S. Cl. CPC B02C 18/24; B02C 18/08; A24B 7/04; B02C 2018/164

(57) ABSTRACT

This invention discloses an electric tobacco grinder, comprising an electric controlling member and a grinding member, wherein: the electric controlling member comprises a body case for electric controlling member, two batteries, a reducing motor, and a PCBA controlling board; the reducing motor is disposed within the inner center of the body case; the batteries are disposed in the corresponding battery container of the body case, wherein the two battery containers are located adjacent to both sides of the reducing motor; the PCBA controlling board is disposed within a flat port of the body case; the grinding member comprises: a grinding upper case, a grinding lower case, a bottom cover, an upper reamer and a lower reamer; the grinding upper case is embedded to fix itself under the body case; the lower reamer is disposed within the grinding lower case that is screwed up beneath the grinding upper case.

### TECHNICAL FIELD

This invention relates to the technical field of smoking products, especially to an electric tobacco grinder.

### BACKGROUND

Nowadays, cigarette usage is widespread, but most of the smokers prefer to directly smoke tobacco, and subsequently the various types of pipes/bowl pipes became popular among smokers. However, the tobacco sold in the market cannot be smoked directly in general. Smokers need to process the tobacco into tobacco fine or shredded tobacco. In general, this step is done manually that costs lots of time and energy. Later on, various tobacco grinders appear on the market, including hand-operated tobacco grinder. However, the efficiency of the hand-operated tobacco grinder is low, and the grinding result cannot be seen while grinding, and subsequently the quality of the grinded tobacco is barely satisfactory. Therefore, an improvement to the grinder is necessary.

### SUMMARY OF THE INVENTION

In order to overcome the above problems of the existing technology, this invention aims to provide an electric tobacco grinder with a reducing motor driving the grinding process, the function of locked-rotor protection, visible grinding effect, and better grinding quality.

This invention solves the technical problem by the following technical solution:

an electric tobacco grinder, comprising an electric controlling member and a grinding member, wherein: the electric controlling member comprises a body case for electric controlling member, two batteries, a reducing motor, and a printed circuit board assembly (PCBA) controlling board; the reducing motor is disposed within the inner center of the body case; the batteries are disposed in the two corresponding battery containers of the body case, wherein the two battery containers are located adjacent to both sides of the reducing motor; the PCBA controlling board is disposed within a flat port of the body case; an upper cover is disposed on the upper part of the body case, and a lower cover is disposed on the lower part of the body case; the grinding member comprises: a grinding upper case, a grinding lower case, a bottom cover, a upper reamer and a lower reamer; the grinding upper case is embedded to fix itself under the body case; the lower reamer is disposed within the grinding lower case that is screwed up to the lower part of the grinding upper case; the bottom cover is screwed up to the lower part of the grinding lower case; a rotating shaft of the upper reamer passes through the grinding upper case and connects with the reducing motor; the PCBA controlling board is powered by the two batteries and connects to the reducing motor; a locked-rotor protecting circuit module is disposed on the PCBA controlling board, the locked-rotor protecting circuit module is configured to protect the reducing motor from getting stuck by electrically controlling the reducing motor to reverse the upper reamer; once reversion of the reducing motor also gets stuck, the PCBA controlling board sends a stop command to stop the rotation of the reducing motor.

As an improvement of this invention: a plurality of antiskid stripes are disposed on the arc part of the body case; a hollow-out window and a triangle button are disposed on the flat port, wherein a plurality of protective bumps are disposed on the rust-proof treated surface of the triangle button; a light guide panel (LGP), which is made of transparent polycarbonate (PC), is placed between the PCBA controlling board and the hollow-out window; the LGP is used for observing the operating light of the PCBA controlling board.

As an improvement of this invention: the grinding upper case, the grinding lower case, and the bottom cover are made of transparent polyvinyl chloride (PVC).

As an improvement of this invention: the battery is 18650 lithium-ion battery; the working voltage of the PCBA controlling board ranges from 6.8V to 8.4V.

As an improvement of this invention: the rotation speed of the reducing motor ranges from 100 to 200 rpm, and the output torque ranges from 10 to 20 Nm.

Compared to the existing technology, this invention has the advantages as follows: this invention uses a reducing motor to drive an upper reamer and a lower reamer to grinding the tobacco and keeps it in an even grinding speed ranging from 100-200 rpm. This provides a faster and even safer way to grind the tobacco than the hand-operated tobacco grinder. What's more, the grinding condition can be clearly seen from the transparent grinding upper case and the transparent grinding lower case during the grinding process, and the shredded tobacco can be seen from the transparent bottom cover, so that the grinding result can be more satisfactory and reduces the repeated and unnecessary overgrinding. In addition, the locked-rotor protecting circuit module of the PBCA controlling board is capable of effectively avoiding the upper reamer and the lower reamer from getting stuck, which consequently burns out the reducing motor. The two 18650 lithium-ion batteries supply power to the PCBA controlling board, which improves the work duration of the product; at the same time, the design of the antiskid strip and the flat port in this invention facilitate the drawing out and putting in of tobacco. The hollow-out window and the LGP enable the working condition of the PCBA controlling board to be clearly observed. In sum, this invention provides a more convenient and durable tobacco grinder, which has the function of locked-rotor protection and can be widely applied to grind tobacco. The tobacco grinding condition is visible and thus a better grinding result can be provided.

### BRIEF DESCRIPTION OF THE DRAWING

FIG. 1 is a structure diagram of this invention;

FIG. 2 is a schematic view of this invention;

FIG. 3 is a sectional view of this invention.

### DETAILED DESCRIPTION OF THE INVENTION

This invention will be further described in conjunction with the drawings and the embodiments.

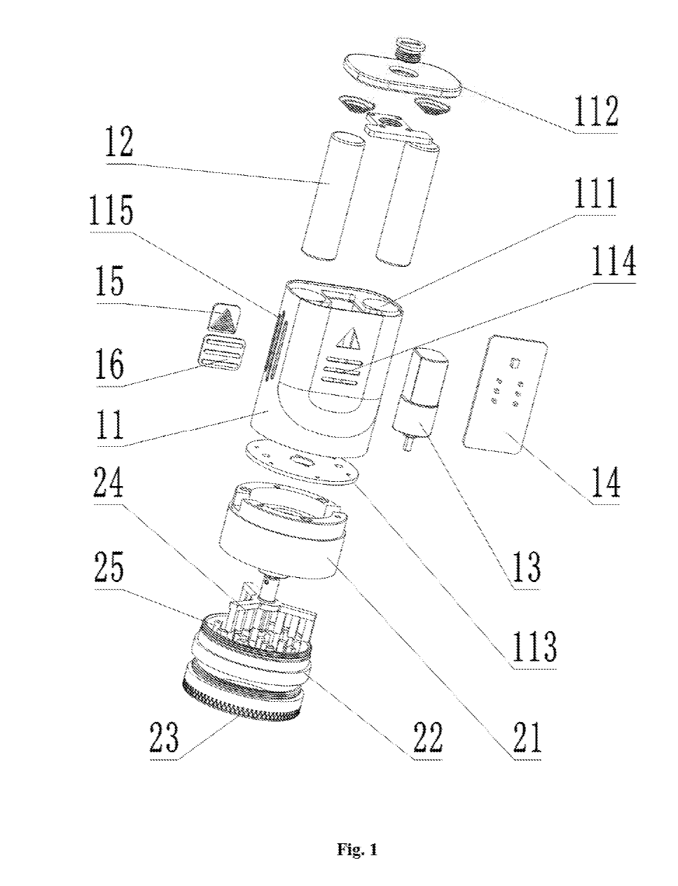

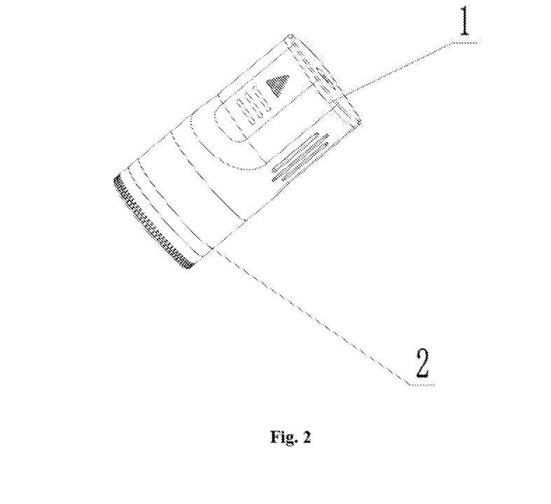

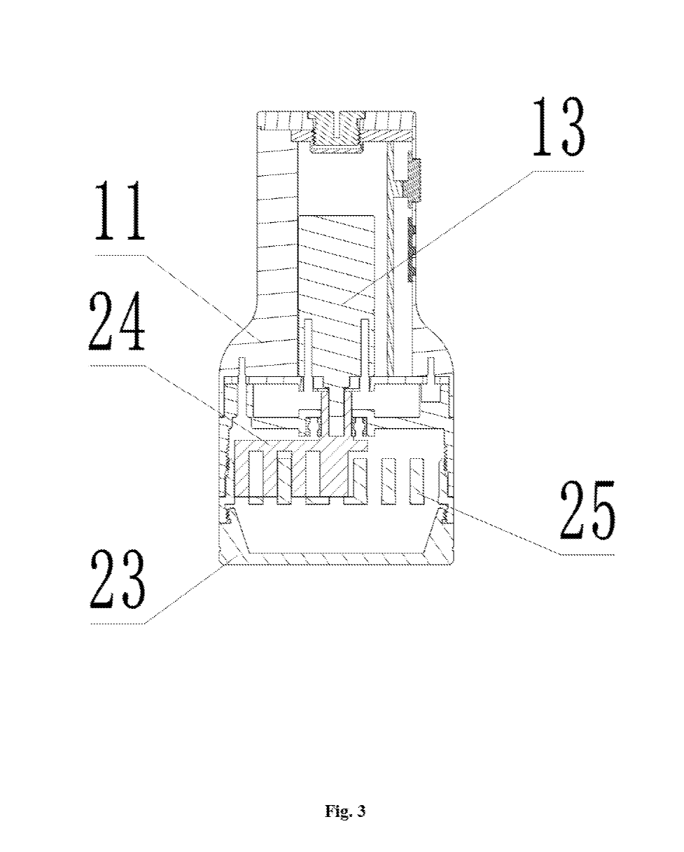

Referring to FIG. 1 to FIG. 3, an electric tobacco grinder, comprising electric controlling member 1 and grinding member 2, wherein: electric controlling member 1 comprises body case 11 for electric controlling member, two batteries 12, reducing motor 13, and PCBA controlling board 14; reducing motor 13 is disposed within the inner center of the body case; batteries 12 are disposed in the corresponding battery container 111 of the body case, wherein the two battery containers 111 are located adjacent to both sides of reducing motor 13; PCBA controlling board 14 is disposed within a flat port of body case 11; upper cover 112 is disposed on the upper part of body case 11, and lower cover 113 is disposed on the lower part of body case 11; grinding member 2 comprises: grinding upper case 21, grinding lower case 22, bottom cover 23, upper reamer 24 and lower reamer 25; grinding upper case 21 is embedded to fix itself to the lower part of body case 11; lower reamer 25 is disposed within grinding lower case 22 that is screwed up to the lower part of grinding upper case 21; bottom cover 23 is screwed up to the lower part of grinding lower case 22; a rotating shaft of upper reamer 24 passes through grinding upper case 21 and connects with reducing motor 13; PCBA controlling board 14 is powered by two batteries 12 and connects to reducing motor 13; a locked-rotor protecting circuit module is disposed on the PCBA controlling board, the locked-rotor protecting circuit module is configured to protect the reducing motor from getting stuck by electrically controlling the reducing motor to reverse the upper reamer; Once being stuck when the PCBA controlling board controls the reducing motor to reverse the upper reamer, the PCBA controlling board sends a stop command to stop the rotation of the reducing motor.

A plurality of antiskid stripes 115 are disposed on the arc part of body case 11; hollow-out window 114 and triangle button 15 are disposed on the flat port, wherein a plurality of protective bumps are disposed on the rust-proof treated surface of triangle button 15; a LGP 16, which is made of transparent polycarbonate (PC), is placed between PCBA controlling board 14 and hollow-out window 114; LGP 16 is used for observing the operating light of the PCBA controlling board 14.

Grinding upper case 21, grinding lower case 22, and bottom cover 23 are made of transparent polyvinyl chloride (PVC), so as to facilitate the observation for the shredded tobacco and realize the grinding progress of the tobacco.

Battery 12 is 18650 lithium-ion battery; the working voltage of the PCBA controlling board ranges from 6.8V to 8.4V. This provides enough power for the PCBA controlling board and subsequently increases the work duration of the product.

The rotation speed of reducing motor 13 ranges from 100 to 200 rpm, and the output torque ranges from 10 to 20 Nm. The low speed rotation provides a safer and better-quality way for grinding, and the controlling of the torque avoids the breakage of the upper and lower reamers, which subsequently increases the service life of the product.

This invention is operated by the following steps: unscrewing the grinding lower case; putting the to-be-grinded tobacco into the grinding lower case; screwing back the grinding lower case; pressing the triangle button, and then the PCBA controlling starts working. The PCBA controlling board controls the rotation of the reducing motor, and supervises the current change of reducing motor via the locked-rotor protecting circuit module. The locked-rotor protecting circuit module detects the current change of the reducing motor when the reducing motor gets stuck driving the upper reamer, and then the PCBA controlling board controls the reducing motor to reverse the upper reamer. At this time, if the reversing also gets stuck, the locked-rotor protecting circuit module can detect the continual increasing current of the reducing motor, and then the PCBA controlling board sends a stop command to stop the reducing motor from rotating the upper reamer. When the reducing motor rotates the upper reamer in normal condition, the cooperation of the upper reamer and the lower reamer grinds the tobacco. The tobacco grinding can be clearly observed from the grinding upper case and the grinding lower case, and the finished product of the grinded tobacco can be clearly observed from the bottom part. Once the grinded tobacco is satisfactory, pressing the triangle button to stop the rotation of the reducing motor, and then unscrewing the bottom cover to draw out the finished product will complete the process.

As described above, any corresponding modification made by one of ordinary skill in the art without creative effort should be considered as falling within the protection scope of this invention.

What is claimed are:

1. An electric tobacco grinder, comprising:
an electric controlling member, and
a grinding member;
wherein:
the electric controlling member comprises a body case for the electric controlling member, two batteries, a reducing motor, and a printed circuit board assembly (PCBA) controlling board; the reducing motor is disposed within the inner center of the body case; the batteries are disposed in corresponding battery containers of the body case, wherein the two battery containers are located adjacent to both sides of the reducing motor, the PCBA controlling board is disposed within a flat port of the body case; an upper cover is disposed on the upper part of the body case, and a lower cover is disposed on the lower part of the body case;
the grinding member comprises: a grinding upper case, a grinding lower case, a bottom cover, an upper reamer and a lower reamer; the grinding upper case is embedded to fix itself to the lower part of the body case; the lower reamer is disposed within the grinding lower case that is screwed up to the lower part of the grinding upper case; the bottom cover is screwed up to the lower part of the grinding lower case; a rotating shaft of the upper reamer passes through the grinding upper case and connects with the reducing motor; the PCBA controlling board is powered by the two batteries and connects to the reducing motor; a locked-rotor protecting circuit module is disposed on the PCBA controlling board, the locked-rotor protecting circuit module is configured to protect the reducing motor from getting stuck by electrically controlling the reducing motor to reverse the upper reamer; if reversing of the reducing motor also gets stuck, the PCBA controlling board sends a stop command to stop the rotation of the reducing motor.

2. The electric tobacco grinder according to claim 1, wherein: a plurality of antiskid stripes are disposed on an arc part of the body case; a hollow-out window and a triangle button are disposed on the flat port; wherein a plurality of protective bumps are disposed on a rust-proof treated surface of the triangle button; a light guide panel (LGP), which is made of transparent polycarbonate (PC), is placed between the PCBA controlling board and the hollow-out window; the LGP is used for observing the operating light of the PCBA controlling board.

3. The electric tobacco grinder according to claim 2, wherein: the grinding upper case, the grinding lower case, and the bottom cover are made of transparent polyvinyl chloride (PVC).

4. The electric tobacco grinder according to claim 1, wherein: the battery is 18650 lithium-ion battery; the working voltage of the PCBA controlling board ranges from 6.8V to 8.4V.

5. The electric tobacco grinder according to claim 1, wherein: the rotation speed of the reducing motor ranges from 100 to 200 rpm, and the output torque ranges from 10 to 20 Nm.
